(19) United States
(12) Patent Application Publication
(10) Pub. No.: US 2021/0129625 A1
(43) Pub. Date: May 6, 2021

(54) ENVIRONMENTAL SAFETY DEVICES AND SYSTEMS FOR A VEHICLE

(71) Applicant: John H. DONBOLI, San Diego, CA (US)

(72) Inventor: John H. DONBOLI, San Diego, CA (US)

(21) Appl. No.: 16/492,515

(22) PCT Filed: Mar. 5, 2018
(86) PCT No.: PCT/US2018/020942

§ 371 Date: Sep. 9, 2019

Related U.S. Application Data
(60) Provisional application No. 62/468,291, filed on Mar. 7, 2017.

(51) Int. Cl. B60H 1/00

(52) U.S. Cl. CPC B60H 1/00807; B60H 1/00428; B60H 1/00264; B60H 1/00742; B60H 1/00978; B60H 1/00535

(57) ABSTRACT

An environmental detection and control system is disclosed for controlling one or more environmental conditions for a cabin of a vehicle. The system can include a housing and one or more sensors disposed with the housing. The one or more sensors can be for detecting environmental conditions of the cabin. A battery may be included with the housing. A microcontroller can also be included to receive input from one or more of the sensors and detecting an alarm condition of the cabin. The microcontroller can actuate one or more alarm response actions in response to the alarm condition being detected. The system can be completely enclosed in a deliverable kit and easily installed in any vehicle.

### FIELD

This disclosure relates to solutions providing safe environments for unattended individuals in vehicles, such as an infants, young children, and pets.

### BACKGROUND

The dangers of leaving passengers and pets unattended in vehicles is well known. For example, young children left in cars during errands, intentionally or mistakenly, can result in grave injury, including death, as a result of temperatures getting too hot in the vehicle. Legislators have recognized the need to address this problem and yet children continue to be left unattended in vehicles. This problem is exacerbated when individuals without much childcare experience are left in charge of children, whereby such individuals have been known to be forgetful or not appreciate the grave risk with leaving children unattended in vehicles. Further, children are not the only victims to this problem.

Indeed, the elderly, infirm, and even pets have fallen victim to being left unattended in vehicles. Other solutions on the market have been known to resolve some of these problems but important problems with these solutions exist. Therefore, it would be desirable to provide a solution to resolve these and other problems plagued by the art.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In some embodiments, an environmental detection and control system is disclosed for controlling one or more environmental conditions for a cabin of a vehicle. The system can include a portable housing and one or more sensors disposed within the portable housing. The one or more sensors can be for detecting environmental conditions of the cabin. A battery may be included with the housing. A microcontroller disposed within the portable housing and can also be included to receive input from one or more of the sensors and detecting an alarm condition of the cabin. The microcontroller can actuate one or more alarm response actions in response to the alarm condition being detected. Often included embodiments of the system provide a temperature control mechanism disposed within the portable housing. Also frequently, a graphical user interface disposed on an outer surface of the portable housing and adapted to control access to a function of the system.

The system can be completely enclosed in a deliverable kit such as a housing and easily installed in a variety of vehicles or compartments, or removably disposed or disposable within a compartment. While vehicle compartments including vehicle cabins or other interior vehicle locations are described herein, that is merely exemplary as the present systems are useful in a variety of confined spaces to protect people and things from overheating, for example, due to environmental exposure.

In certain frequent embodiments, presence of an occupant within an internal space such as the cabin of a vehicle is a precondition to an alarm condition occurring. An occupant is often an animal such as a human, but may be other living species, non-living items or things. The presence of the occupant may be detected by a sensor of the system, often included on the housing of the system or operably connected (e.g., physically plugged in or connected via short range wireless data transmission) with the system. Also, the presence or absence of the occupant may be pre-selected by a user of the system that can toggle between a plurality of settings, often via a user interface such as an input/output device or graphic user interface (GUI). Often, a GUI is disposed on an outer surface of the portable housing and adapted to control access to one function of the system, two or more functions of the system, or a plurality of functions of the system by a user of the GUI. Exemplary functions of the system are described herein throughout. In certain embodiments, the GUI is reduced to buttons, knobs, dials, levers and the such. In certain other embodiments, the GUI is a graphic display such as an LCD display or similar with touch-screen capability.

In certain frequent embodiments, a battery, often a rechargeable battery, is be included in the housing and in communication with the one or more sensors and disposed with the housing. Often in such embodiments, the system comprised in the housing is not powered by the vehicle, but can derive its power (optionally its entire breadth) from the battery.

In some embodiments, one of the sensors is a cabin vehicle temperature sensor. The alarm condition can be a predetermined temperature range such that the microcontroller causes the one or more alarm response actions when a temperature of the cabin is detected as being outside of the predetermined temperature range. The predetermined range can be any range and be set by the manufacturer or adjustable by the end user. For example, one range can be that the cabin temperature not exceed 85 degrees F. Other sensors can include a GPS unit, a cushion pressure sensor, an accelerometer, an engine state sensor, an infrared sensor operable to detect a presence of a passenger.

In some embodiments where an IR sensor is included, the system remains in a sleep mode until awakened by a signal from one of the sensors indicating detection of the presence of the passenger. The infrared sensor can transmit output to the microcontroller to awaken the system from a sleep mode. In those embodiments where an engine state sensor is included, the engine state sensor detects whether an engine of the vehicle is running so that the system only is in an alarm condition detect mode when the engine state sensor senses the engine is running.

In some embodiments, the housing can also include or being attached to another larger housing with a temperature control mechanism. In this respect, when the alarm condition is detected the microcontroller transmits output to the temperature control mechanism and causes the temperature of the cabin to move to the predetermined temperature range. The temperature control mechanism can be a portable air condition unit that uses a refrigerant to lower the temperature of the cabin. For example, the portable air condition unit can include refrigerant, a compressor, a condenser, an evaporator, an evaporator fan, and a condenser fan within its housing. Often the temperature control mechanism is not part of the vehicle, for example the vehicle's air conditioning system. In frequent exemplary embodiments, the environmental detection and control system provides an alarm response action such as a temperature control mechanism without operating the vehicle. Also in frequent exemplary embodiments, the environmental detection and control system is self-contained in a housing and provides an alarm response action such as a temperature control mechanism without operating the windows or air conditioning system of the vehicle where the housing is placed.

In some embodiments, one of the sensors is a temperature sensor for measuring temperature outside the vehicle. Similarly, the alarm condition can be defined by a predetermined temperature range such that the microcontroller causes the one or more alarm response actions when a temperature outside the vehicle is detected as being outside of the predetermined temperature range.

In some embodiments, one or more sensors can be attached on an external surface of the housing, internal to the housing, or remotely connected therewith. A sensor panel can also be included with the system, wherein each or some of the one or more sensors are disposed on the sensor panel. The sensor panel can be connected to the microcontroller via a cable or also wirelessly connected. The housing can also include one or more externally positioned fasteners for releasably attaching to a plurality of positions in the cabin of a vehicle (e.g. hook and loop fastener tabs).

In some embodiments, a solar panel and an electrical energy storage system can be included with the system for charging a battery of the system. Often in such embodiments, the system comprised in the housing is not powered by the vehicle, but can derive its power (optionally its entire breadth) from solar power by way of the chargeable battery or electrical storage system.

In some embodiments, an audible alarm mechanism can be included for emitting an alarm sound as one of the alarm response actions.

In some embodiments, the housing can also include an audible alarm mechanism for emitting an alarm sound, for example, when an alarm condition is detected and/or due to the presence of a passenger has been detected and a door of the vehicle is detected to be open without a detected driver. In some embodiments, the housing can also include a visible alarm mechanism for emitting a visible signal.

In some embodiments, the system is wirelessly connected to a computer of the vehicle through radio waves such as wireless LAN, Bluetooth, WiMAX, WiMAX2, LTE, and/or HSDPA. In this respect, the microcontroller can transmit output to the computer when the alarm condition is detected and an alarm sound of the vehicle is caused to emit. The microcontroller can also cause one or more positions of windows of the vehicle are adjusted, a position of one or more doors of the vehicle to be adjusted.

In some embodiments, when the alarm condition is detected the system is automatically connected to an alarm notification system and the microcontroller automatically transmits output to the alarm notification system and one or more alarm notifications are transmitted to individuals or an alarm response team. The alarm notification system can be a call center such as a 911 call center, an ONSTAR call center, an ATX call center, a Cross Country call center, or ADT call center.

In some embodiments, the system is wirelessly connected to an external computing device and/or a remote sensor through radio waves such as wireless LAN, Bluetooth, WiMAX, WiMAX2, LTE, and/or HSDPA. The external computing device can communicate with the environmental detection and control system through an application resident on the external computing device to remotely monitor and/or control one or more alarm response actions. The external computing device can be a smart phone or a tablet.

In some embodiments, a method of detecting and controlling an environment of a vehicle is disclosed. The method can include detecting one or more environmental conditions of a cabin of the vehicle; determining if an alarm condition exceeds a predetermined threshold; and actuating one or more alarm response actions in response to the alarm condition being detected.

A response action is often a direct cooling action that absorbs heat or provides an emission of cool air directly from the housing of the system. In often included embodiments, a response action is not dependent on any function, data, and/or power of the location (e.g., the vehicle) where the system is placed and operational. A response action may also frequently include a communication. In certain frequent embodiments, a direct cooling action and a communication are provided in a response action. The communication is optionally a communication to a vehicle electrical subsystem where the system is placed. The communication may also/additionally be an external communication to a device, person, or organization outside of the vehicle where the system is placed. The communication may also/additionally be an internal communication within the vehicle such as an audible alert and/or visual signal. Such communications often provide an indication regarding one or more environmental conditions within the vehicle or otherwise as measured by the system, including a sensor thereof. Such communications may also provide a command such as inducing the vehicle to activate one or more is electric subsystems such as an ignition system, air conditioning system, window actuation system, etc.

A response action is often an automated action. A response action may also be manually-actuated action by a user, and/or remote-actuated action by a user. In certain embodiments, the response action is a blended automated action with a manually-actuated action by a user, and/or remote-actuated action by a user. When automated, the response action occurs without any further user input based on a detected (e.g., measured) environmental condition such as temperature. When the system provides multiple response actions, one or more of the actions may be an automated action leaving one or more other response actions to be manually-actuated and/or remote-actuated. When manual or remote actuated, the response action depends on input from a user directly on an input terminal, through the vehicle, and/or through a remote/mobile device, terminal, site or application. In a blended automated action, an automated action is often a notification communication to a user whereby a manual or remote actuated response action is available to the user to employ a separate response action of the system such as a cooling action.

In certain embodiments, the systems provided herein operate regardless of the presence of an occupant within the vehicle compartment. In such embodiments, an alarm condition is often a pre-set environmental condition threshold such that the response action acts to moderate that or a related environmental condition in the compartment of the vehicle. Such embodiments are frequently employed to moderate the temperature of the vehicle to not exceed a particular temperature while a user of the vehicle is absent from the vehicle. In such embodiments, temperature sensitive contents of the vehicle compartment can be preserved or maintained.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 depicts a perspective schematic view of an example environmental detection and control system for a vehicle with environmental sensors disposed on its housing.

FIG. 2 is a perspective view of the environmental detection and control system of a vehicle.

FIG. 3 depicts a perspective schematic view of an example environmental detection and control system for a vehicle with a solar cell disposed on its housing.

FIG. 4 depicts a perspective schematic view of an example environmental detection and control system for a vehicle with a solar cell disposed on the housing.

FIG. 5 depicts a perspective schematic view of an example environmental detection and control system for a vehicle.

FIG. 6 depicts a kit including any of the herein disclosed environmental control systems for installation in a vehicle.

FIG. 7 depicts a schematic overview of operating conditions being controlled remotely by an external computing device.

FIG. 8 depicts a schematic over of exemplary architecture of an external computing device for use with any of the herein disclosed environmental detection and control systems.

FIG. 9 is a schematic overview of a method of detecting and controlling an environment in a vehicle.

### DETAILED DESCRIPTION

The features of the presently disclosed solution may be economically molded or assembled by using one or more distinct parts and associated components which, may be assembled together for removable or integral application. Unless defined otherwise, all terms of art, notations and other scientific terms or terminology used herein have the same meaning as is commonly understood by one of ordinary skill in the art to which this disclosure belongs.

In some cases, terms with commonly understood meanings are defined herein for clarity and/or for ready reference, and the inclusion of such definitions herein should not necessarily be construed to represent a substantial difference over what is generally understood in the art. All patents, applications, published applications and other publications referred to herein are incorporated by reference in their entirety. If a definition set forth in this section is contrary to or otherwise inconsistent with a definition set forth in the patents, application, published applications and other publications that are herein incorporated by reference, the definition set forth in this section prevails over the definition that is incorporated herein by reference.

As used herein, “a” or “an” means “at least one” or “one or more.”

As used herein, the term “user”, “subject”, “end-user” or the like is not limited to a specific entity or person. For example, the term “user” may refer to a person who uses the systems and methods described herein, and frequently may be a technician. However, this term is not limited to end users or technicians and thus encompasses a variety of persons or entities who can use or benefit from the employment of the disclosed systems and methods.

The term “sensor” can mean one or more mechanisms that can detect or measure a physical property and/or an environmental condition (e.g. position, temperature, speed, rate of acceleration, gas level, sound, pressure, etc.).

The term “vehicle” can mean an enclosed automobile such as a car.

The term “call center” can mean one or more emergency response centers (e.g., a 911 call center, an ONSTAR call center, an ATX call center, a Cross Country call center, or ADT call center).

The term “passenger” can mean any individual that can ride in a vehicle, including an infant, a toddler, or any other child as well as an animal.

As used herein, the term “housing” refers to the external enclosure of an environmental detection and control system of the present disclosure as well as the internal structures that support components of the machine therein. The housing may include a user interface area including at least one input/output device through which the system may receive at least one input (e.g., from a user of the system) or deliver an output e.g., to a user of the system). The housing may be thermally dynamic such that it absorbs heat, pulls in hot air, and/or emits cool gas (e.g., air, oxygen, inert gas blends, physiologically compatible gas, etc.). One or more openings/vents may be provided in the housing if gas circulation or emission is provided as an alarm response action. A housing of the presently disclosed systems does not include the vehicle or cabin or compartment thereof within its definition, but rather defines a stand-alone functional system. Most frequently this portable system is disposable in a compartment (and removable therefrom) and fully functional without requiring any specialized training or experience of the installer. Also frequently this portable system fully functional without having to make use of, for example, the air conditioning or an internal sensor (e.g., a passenger sensor) of the vehicle. The housing of the portable systems described herein is adapted to be of sufficient size to incorporate the necessary functional aspects, while minimizing its intrusion into free available space in a compartment. In certain embodiments, the housing of the system is a hollow enclosure. In certain related embodiments, the housing of the system is a hollow enclosure having a height of 18 inches or less. Also, in certain embodiments, the housing of the system is a hollow enclosure having a height of approximately 18 inches and a width of approximately 12 inches. Also, in certain embodiments, the housing of the system is a hollow enclosure having a rounded, dome, or puck-like shape having a height of approximately 18 inches or less and a width or diameter of approximately 18 inches or less.

As used herein, “portable” refers to an integrated device or system that can be placed within a compartment (e.g., the cabin or interior of a vehicle) in fully functional form and removed from that compartment in fully functional form to be used in the same or a different vehicle, by a user without the need for any specialized training or knowledge in automotive electrical systems or automotive assembly or repair. Most frequently, a portable system is comprised in a housing.

The disclosed solution can now better understood turning to the following detailed description. It is to be expressly understood that the illustrated embodiments are set forth as examples and not by way of limitations on the embodiments as ultimately defined in the claims.

Connectivity of the device with outside data sources is a frequent aspect of the disclosed systems. In such connectivity the system comprises an outside data source in electronic data communication with the device. The outside data often comprises weather data and/or weather forecast data. The outside data also often comprises geographic positioning data, Global Positioning System (GPS) data or another positioning data source that provides data about the specific positioning of the device at a present time or specific data about the planned or predicted positioning of the device in the future. Such positioning data may be real-time or prospective. Such positioning data may also be provided in the system comprises a processor and a computer readable medium that calculates or combines the positioning data with the weather data to identify or predict the temperature of the location of the system. If the device includes a local thermometer-based temperature sensor, that information is also considered in the activation sequence. The device, therefore, includes a manner of data receipt and transmission that may be via mobile data or a Bluetooth or other wireless WiFi connection with a hotspot or with the vehicle in which the device is placed. In certain frequent embodiments, the device is capable of receiving and transmitting mobile data using cellular data.

Based on this prediction, the system may automatically enter a ready-mode or an emergency mode such that the device can become, or is, instantly activated. In certain embodiments, the timing that the device has been present in a high heat environment, as determined from the positioning and weather data, alone may optionally or automatically shift the device into the “ready” or “activation” state. Activation may be automatic or via a web-based application that is user controllable. In other related embodiments, the weather and positioning data are combined prior to processing in the device processor. In one exemplary sequence, the device is placed in a ready mode or activated when it is determined that the device is positioned in a high heat environment for a predetermined amount of time. Often, this data is combined with onboard sensor data that identifies the presence of a passenger or specific item in the vehicle. A high heat environment may be over 80, 85, 90, 95, 100, or over 100 degrees Fahrenheit. Also, a high heat environment may comprise a combination of temperature and solar exposure data such that a high heat environment is identified with a lower temperature, but with a high or heightened solar exposure. Conversely, in a low solar exposure environment (e.g., cloudy, rain, etc.), the high heat environment may be identified with a higher initial temperature threshold. In certain embodiments, wind data forms a component of the weather data processed by the system.

A web-based application (App) for use on a mobile device often forms an aspect of the present systems such that one or more devices can be placed in data communication with the App. The systems described herein may be fully operated via the App. In certain embodiments, the App provides the App user with status information related to the environment of the device connected with the App. In certain embodiments, the device includes an onboard camera that is operable or accessible via the App to provide, for example, a view of the local environment surrounding the device. Such a camera is useful when the presence of a passenger or item is in question, or to verify suspected data or information.

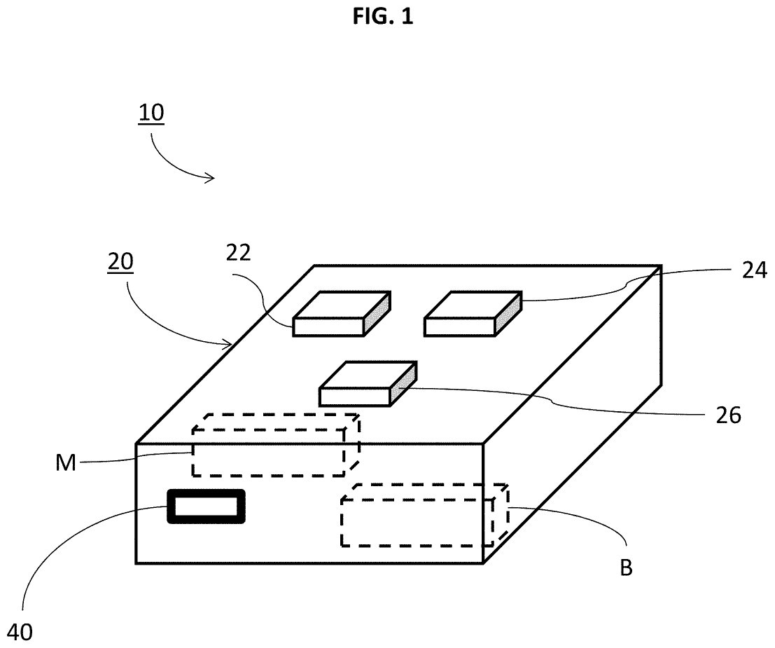

FIG. 1 depicts a perspective view of control system 10 for controlling one or more environmental conditions of the cabin of a vehicle. As can be seen, system 10 can include a housing 20 that is hollow and capable of housing microcontroller M and battery B. Electrical power can be provided to the system 10 internally through battery B though system 10 is not so limited and can be connected to the electrical supply of vehicle V. One or more sensors 22, 24, 26 can also be included with system 10 for detecting one or more environmental conditions. For example, sensor 22 can be a temperature sensor, sensor 24 can be a gas sensor, and sensor 26 can be an infrared sensor. Housing 20 can also have other components not depicted, including electrical circuitry, hardware components, a battery level indicator, a rest button, as well as other actuator buttons. In certain embodiments, the gas sensor 24 can be a gas sensor for measuring CO₂ levels within the vehicle V. Such levels can be analyzed by microcontroller M and if a threshold difference has been determined in the cabin of vehicle V, an alarm condition will be detected and a response action can be initiated by microcontroller M. The alarm condition in this instance can be set at the factory or be automatically determined by microcontroller M based on a baseline detected level.

One of the sensors of system 10 can also be a sound sensor. For example, microcontroller M can receive input from the sound sensor and be capable of determining whether an alarm condition is satisfied based on a passenger exceeding a decibel level, amplitude, pattern or frequency (e.g. crying, screaming, etc.) or an alarm sound from a pet such as a dog barking.

One of the sensors of system 10 can also be a camera. In this respect, system 10 can include program instructions whereby input from the camera can be recognize passengers and determine one of vehicle V's previous passengers is in the cabin with the doors closed, motor off, and a driver absent. It is understood that only one sensor may be included or any number of additional sensors can be included as needed or required. For example, a cushion pressure sensor or pressure pad associated with a child seat can be included with system 10 and be attached to or in communication with a seat of vehicle V (e.g. a child safety seat). Such a sensor could be directly or wirelessly connected to system 10 to inform system of the presence of a passenger. Any of the herein disclosed environmental control systems, including system 10, can wirelessly connect to computer C and/or an external computing device through radio waves such as through wireless LAN, Bluetooth, interoperable implementations of the IEEE 802.16 family of wireless-networks standards ratified by the WiMAX Forum (WiMAX), Long-term Evolution (LTE), High-Speed Downlink Packet Access (HSDPA) (hereinafter “wirelessly connected”). Optionally, system 10 can also communicated with computer C of vehicle V when an alarm condition has been detected and cause a horn of the vehicle V and/or emergency lights of vehicle V to actuate as an alarm response action.

As described more particularly below, when presence of a passenger has been detected, this presence can cause microcontroller M to actuate system 10 from a sleep mode to an alarm sensing mode. In a sleep mode, system 10 would conserve resources to prolong durations between charging battery B.

Housing 20 can also include one or more ports 40 for introducing a cable with system 10. For example, port 40 can be a USB port for charging and/or transmitting data with system 10. Housing 20 may also include one or more alarm sound emitters for emitting an alarm sound when an alarm condition has been detected by system 10.

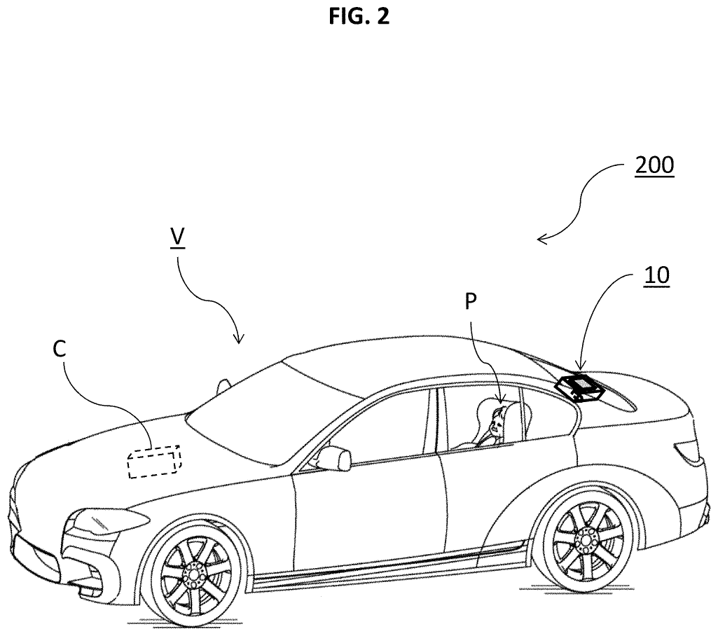

FIG. 2 shows a vehicle V having a cabin with a passenger P who has been left unattended. Vehicle V is equipped with vehicle cabin control system 10 which together forms safety control system 200. As previously described, system 10 can include one or more environmental sensors for monitoring environmental conditions of the vehicle V.

System 10 can be positioned anywhere with vehicle V, including inside its cabin, attached underneath its sunroof, in adjacent the rear window as shown, or even externally on top of the roof of vehicle V.

System 10 can be directly (e.g. through one or more wires) or wirelessly connected to computer C of vehicle V in order to control certain features of vehicle in response to one or more alarm conditions. For example, if an alarm condition such as a predetermined temperature threshold is detected by system 10 as being exceeded in the cabin of vehicle V, system 10 will communicate can communicate with computer C so one or more actions are taken. For example, system 10 can cause a door or window of vehicle V to be opened or adjusted. System 10 can also actuate the A/C of vehicle to actuate.

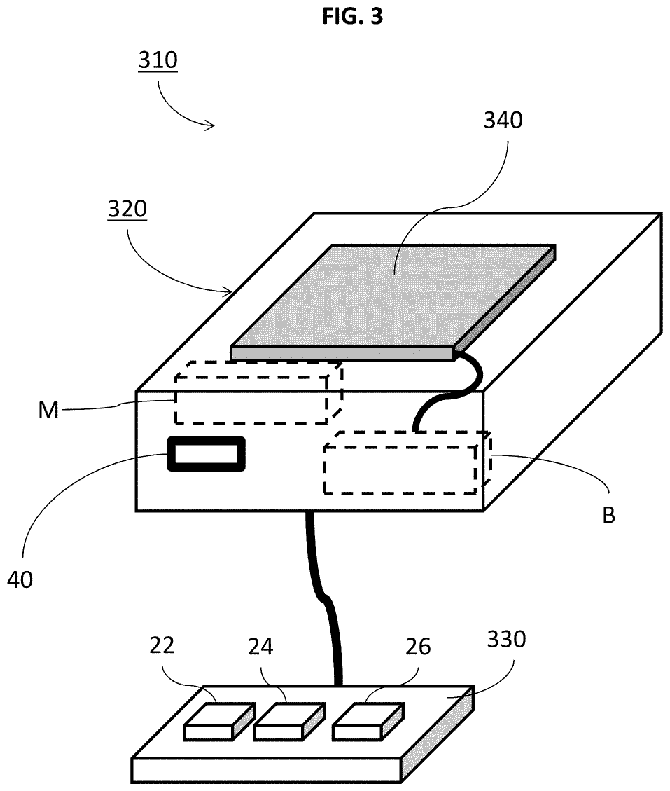

FIG. 3 depicts a perspective view of another control system 310 with a solar panel 340 disposed on housing 320. Panel 340 can be cable of collecting and storing energy from sun rays, and using said energy to charge battery B of system 310. Preferred embodiments of system 310 can include panel 340 having one or more flat panels of solar cells, and preferably with minimal or no unaesthetic protuberances and exposed equipment. Panel 340 can utilize photovoltaic panel(s), for example amorphous photovoltaic laminate (PVL).

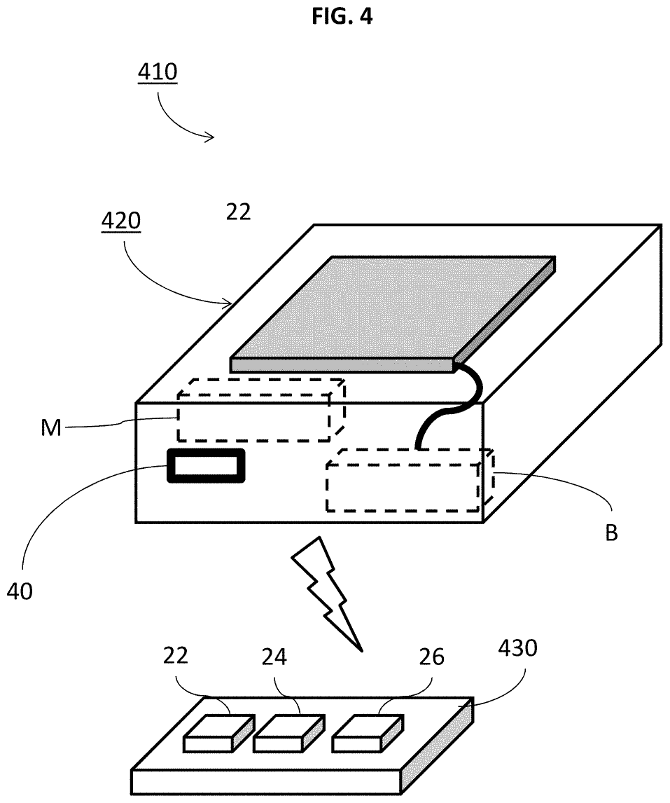

System 310 can also include a separate panel 330 for receiving sensors 22, 24, 26 and movably positioning them through the cabin of vehicle V. As can be seen, battery B, microcontroller M and other features of system 310 can be directly connected to panel 310 and sensors 22, 24, 26 through one or more cables. System 310 is not so limited, however, and any of sensors 22, 24, 26 can be selectively positioned in the cabin of vehicle V without such a panel 330 and or without a corresponding cable (see, e.g., FIG. 4).

FIG. 4 depicts a perspective view of another control system 410, similar to system 310, wherein housing 420 has solar panel 440 disposed on thereon and is electrically connected to battery B. Sensors 22, 24, 26 can be positioned on a separate panel 430, wherein the panel 430 and/or one or all of the sensors can be wirelessly connected to microcontroller M of system 410.

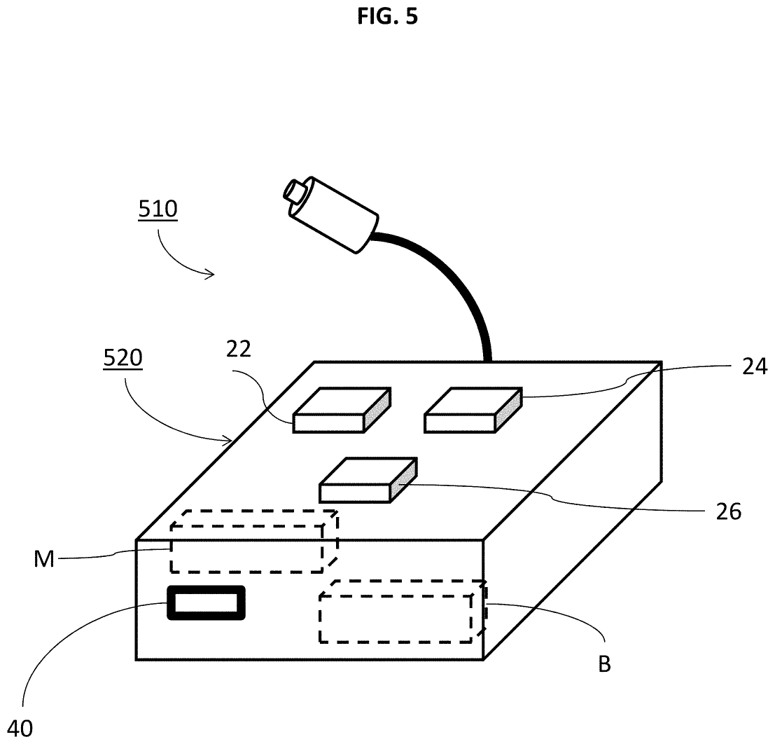

FIG. 5 depicts a perspective view of control system 510, similar to previously disclosed systems 10, 210, 310, 410, wherein housing 520 can be seen with sensors 22, 24, 26, microcontroller M, and battery B. A cable is shown extending from a rear portion of housing 520 for connecting to a vehicle power supply (e.g. a car lighter).

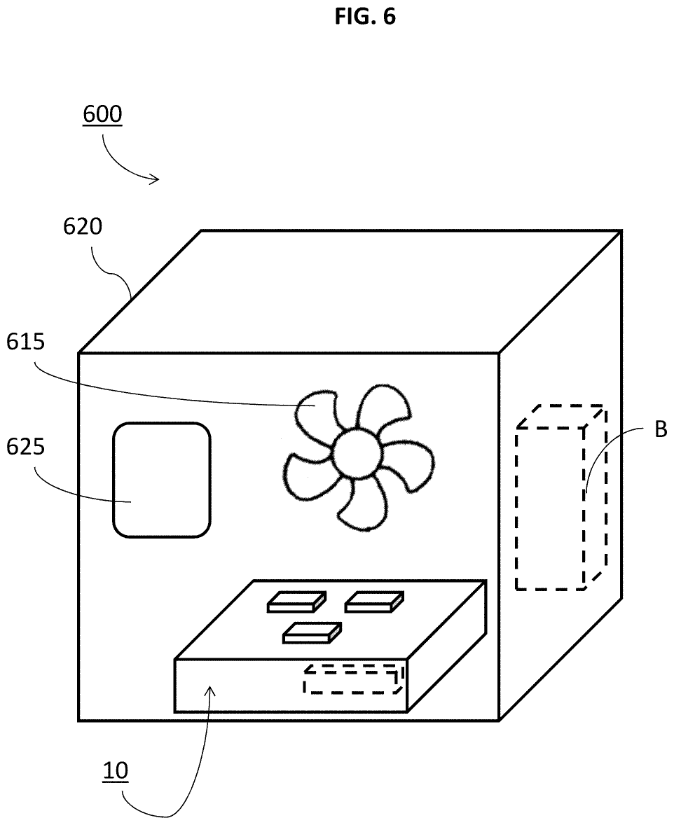

FIG. 6 depicts another embodiment of the solution of this disclosure embodied in a kit 600 prior to installation in vehicle V. Kit 600 can be fully portable and include one or more environmental controlling mechanisms within its housing that can be actuated within and control conditions in the cabin of vehicle V, such as temperature. It is understood that kit 600 can be a temperature control mechanism with a portable air condition unit within its housing that uses a refrigerant to lower the temperature of the cabin. Kit 600 may therefore include its own rechargeable battery B (or otherwise be connected to an external power supply such as the vehicle V). Kit 600 can include a housing 620 with any of the herein disclose environmental control systems. For example, housing 620 also include fan 615, engine blower and refrigerant compressor 625 coupled together in the direct drive arrangement as well as an evaporator, condenser, etc. The compressor 620 can be connected in a circuit with the condenser, the evaporator, and the expansion device, and a refrigerant (e.g. an aerosol such as Freon) has the ability to turn from liquid into vapor, and by that change in temperature of the cabin of the vehicle V. It is understood that kit 600 can adjust environmental conditions of the cabin of vehicle V without any support from computer C, or any other switches or components of vehicle V (e.g. doors, windows, or even the A/C of vehicle V). For simplicity, kit 600 is depicted in FIG. 6 with system 10 but any other herein disclosed control system can be used as needed or required. System 10 can be attached or positioned in housing 620 permanently or through any detachable fastening means (e.g. bolt, hook and loop, cable, clamp, coupling, hook, latch, etc.). Similarly, kit 600 can be attached or positioned in the cabin of vehicle V permanently or through any detachable fastening means (e.g. bolt, hook and loop, cable, clamp, coupling, hook, latch, etc.).

Any of the herein disclosed environmental control and detection systems may also be wirelessly controlled by an external computing device E. In this respect, the system and the external computing device can be directly or wirelessly connected. The external computing device E may optionally communicate with the system through an application resident on the external computing device E to remotely monitor the controls associated with the system, including temperature controls or vehicle environmental controls such as window or door switches or even the HVAC system of the vehicle. The external computing device E can be a phone, a tablet, a laptop, a watch, or a desktop computer.

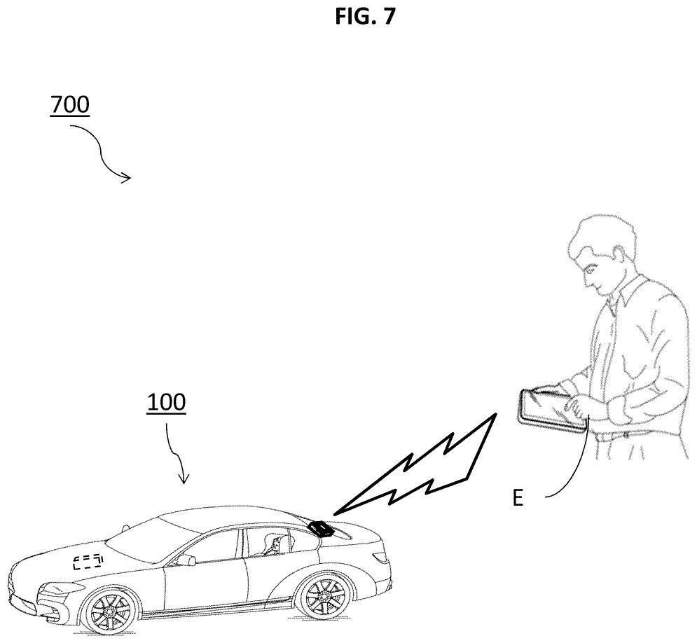

Similarly, as seen in FIG. 7, any of the herein disclosed environmental control systems can be wirelessly connected to an external computing device E to form control system 700. It is understood that device E may be a smart phone, tablet, laptop, desktop computer, or the like. The environmental detection and control system can be wirelessly connected and controlled by device E. External computing device E may operatively communicate with the environmental detection and control system preferably through an application resident on device E.

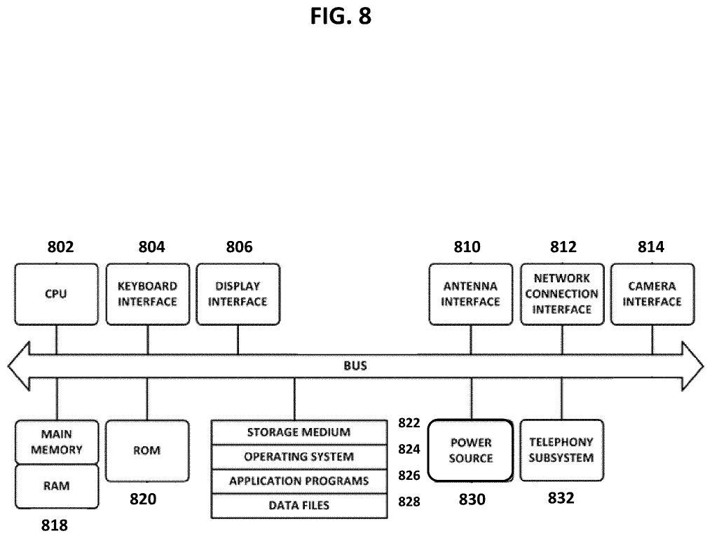

Exemplary architecture of device E is shown in FIG. 8 that can control system 10 includes a central processing unit (CPU) 802, where computer instructions are processed; a display interface 806 that acts as a communication interface and provides functions for rendering video, graphics, images, and texts on the display 806 and a keyboard interface 804 that provides a communication interface to a keyboard; and a pointing device interface that provides a communication interface to system 10. Example embodiments of the architecture may include an antenna interface 810 that provides a communication interface to an antenna. Example embodiments may include a network connection interface 812. The network connection interface 812 may provide a communication interface to an external device or network. In certain embodiments, a camera interface 814 may be provided that acts as a communication interface and provides functions for capturing digital images from a camera that can be connected with system 10. According to example embodiments, a random access memory (RAM) 818 may be provided, where computer instructions and data may be stored in a volatile memory device for processing by the CPU 802.

According to an example embodiment of FIG. 8, the architecture may include a read-only memory (ROM) 820 where invariant low-level system code or data for basic system functions such as basic input and output (I/O), startup, or reception of keystrokes from a keyboard are stored in a non-volatile memory device. According to an example embodiment, the architecture may include a storage medium 822 or other suitable type of memory (e.g. such as RAM 818, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 824, application programs 826 (including, for example, a web browser application, a widget or gadget engine, and or other applications, as necessary) and data files 828 are stored. According to an example embodiment, the architecture may include a power source 830 that provides an appropriate alternating current (AC) or direct current (DC) to power components. According to an example embodiment, the architecture may include a telephony subsystem 832 that allows the device to transmit and receive sound over a telephone network. The constituent devices and the CPU may communicate with each other over a bus.

In accordance with an example embodiment of FIG. 8, the CPU 802 may have appropriate structure to be a computer processor. In one arrangement, the computer CPU 802 may include more than one processing unit. The RAM 818 may interface with the computer bus to provide quick RAM 818 storage to the CPU 802 during the execution of computing programs such as the operating system 824 application programs 126, and device drivers. More specifically, the CPU 802 may load computer-executable process steps from the storage medium 822 or other media into a field of the RAM 818 in order to execute computing programs. Data may be stored in the RAM 818, where the data may be accessed by the computer CPU 802 during execution.

The storage medium 822 itself may include a number of physical drive units and a computer program product embodying any of the foregoing systems and solutions, may be tangibly embodied in storage medium 822, which may comprise a machine-readable storage medium 822.

The herein disclosed environmental detection and control systems can also utilize a novel system of power conservation whereby the system can remain primarily in a (power conserving) “sleep mode” and is only awakened when one of the sensors of the system detects presence of a passenger (e.g. when a passenger sits on a cushion or an infrared disturbance is detected by an IR sensor).

Accordingly, one of the sensors of the environmental detection and control system can be a passive infrared sensor or cushion pressure sensor. A passive infrared sensor in particular offers the advantage of low power detection of thermal gradients and uses far less power than other sensors, the resulting system requires far less power than a sensor that is otherwise always activated. This is advantageous as it can extend the life of the environmental detection and control system between charges or not been directly reliant to an external power supply such as the power plant of the vehicle V.

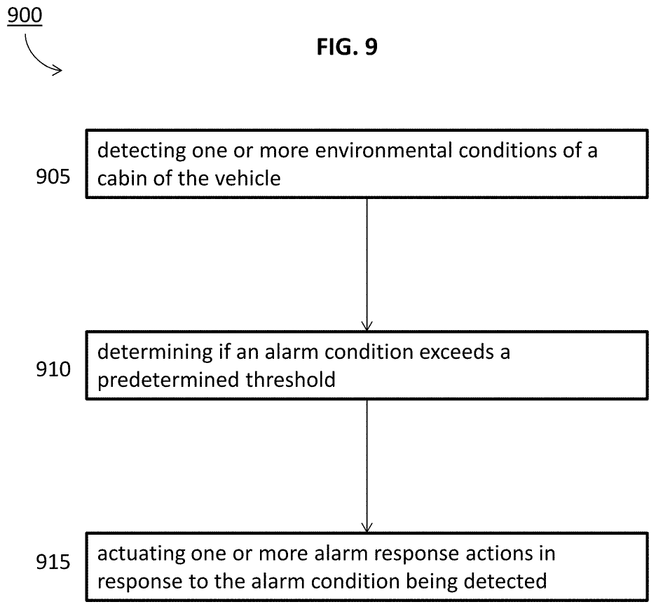

Finally, turning to FIG. 9, a method 900 of controlling and detecting environmental conditions of a vehicle is shown. In step 905, the method includes detecting one or more environmental conditions of a cabin of the vehicle. In step 910, the method includes determining if an alarm condition exceeds a predetermined threshold. In step 915, the method includes actuating one or more alarm response actions in response to the alarm condition being detected. In other embodiments, upon detection of one or more alarm conditions, a call center can be automatically contacted by any number of means. For example, an alarm response action can be one or more messages (e.g. SMS, MMS, email, or encrypted communication means) with details of the alarm (e.g. how long the temperature has been outside of the predetermined temperature range) as well as GPS coordinates of the vehicle. Emergency first responders can then be notified as well as an emergency contact list associated with the system (e.g. family or friends).

The definitions of the words or elements of the following claims are, therefore, defined in this specification to not only include the combination of elements which are literally set forth. It is also contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination(s).

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An environmental detection and control system for a cabin of a vehicle, the system comprising:
a portable housing;
one or more sensors disposed within the portable housing, the one or more sensors for detecting environmental conditions of the cabin;
a microcontroller disposed within the portable housing and operable to receive input from one or more of the sensors and detecting an alarm condition and actuating one or more alarm response actions in response to the alarm condition being detected;
a temperature control mechanism disposed within the portable housing; and
a graphical user interface disposed on an outer surface of the portable housing and adapted to control access to a function of the system.

2. The system of claim 1, wherein the portable housing is removably disposable within a compartment.

3. The system of claim 2, wherein the compartment is the cabin or interior of a vehicle.

4. The system of claim 2, wherein the portable housing is a hollow enclosure having a height of approximately 18 inches and a width of approximately 12 inches.

5. The system of claim 2, wherein the portable housing is a hollow enclosure having a height of 18 inches or less.

6. The system of claim 1, further comprising a battery in communication with the one or more sensors and disposed with the portable housing.

7. The system of claim 1, wherein one of the sensors is a cabin vehicle temperature sensor.

8. The system of claim 7, wherein the alarm condition is defined by a predetermined temperature range, and wherein the microcontroller causes the one or more alarm response actions when a temperature of the cabin is detected as being outside of the predetermined temperature range.

9. The system of claim 8, wherein the predetermined range does not exceed 85 degrees F.

10. The system of claim 8, wherein the one or more alarm response actions are operable regardless of the presence of an occupant in a cabin of the vehicle.

11. The system of claim 10, wherein when the alarm condition is detected the microcontroller transmits output to the temperature control mechanism and causes the temperature of the cabin to move to the predetermined temperature range.

12. The system of claim 10, wherein the temperature control mechanism is a portable air condition unit that uses a refrigerant to lower the temperature of the cabin.

13. The system of claim 10, wherein the temperature control mechanism is a portable air condition unit comprising refrigerant, a compressor, a condenser, an evaporator, an evaporator fan, and a condenser fan.

14. The system of claim 1, wherein one of the sensors is a temperature sensor for measuring temperature outside the vehicle.

15. The system of claim 14, wherein the alarm condition is defined by a predetermined temperature range, and wherein the microcontroller causes the one or more alarm response actions when a temperature of outside the vehicle is detected as being outside of the predetermined temperature range.

16. The system of claim 15, wherein the predetermined range does not exceed 85 degrees F.

17. The system of claim 1, the one or more sensors is attached on an external surface of the housing.

18. The system of claim 1, further comprising a solar panel and an electrical energy storage system.

19. The system of claim 1, the portable housing further comprising an audible alarm mechanism for emitting an alarm sound as one of the alarm response actions.

20. The system of claim 1, the portable housing further comprising an audible alarm mechanism for emitting an alarm sound when presence of a passenger has been detected and a door of the vehicle is detected to be open without a detected driver.

21. The system of claim 1, the portable housing further comprising one or more externally positioned fasteners for releasably attaching to a plurality of positions in a cabin of a vehicle.

22. The system of claim 21, wherein fasteners are hook and loop fastener tabs.

23. The system of claim 1, further comprising: a solar panel disposed on or in communication with the housing and/or the battery, the solar panel operable to charge the battery.

24. The system of claim 1, further comprising: a sensor panel, wherein each of the one or more sensors are disposed on the sensor panel.

25. The system of claim 24, wherein the sensor panel is connected to the microcontroller via a cable.

26. The system of claim 24, wherein the sensor panel is wirelessly connected to the microcontroller.

27. The system of claim 1, wherein the system is wirelessly connected to a computer of the vehicle through radio waves such as wireless LAN, Bluetooth, WiMAX, WiMAX2, LTE, and/or HSDPA.

28. The system of claim 27, wherein the microcontroller transmits output to the computer when the alarm condition is detected and an alarm sound of the vehicle is caused to emit.

29. The system of claim 27, wherein the microcontroller transmits output to the computer when the alarm condition is detected and one or more positions of windows of the vehicle are adjusted.

30. The system of claim 27, wherein the microcontroller transmits output to the computer when the alarm condition is detected and a position of one or more doors of the vehicle is adjusted.

31. The system of claim 1, wherein when the alarm condition is detected the system is automatically connected to an alarm notification system and the microcontroller automatically transmits output to the alarm notification system and one or more alarm notifications are transmitted to individuals or an alarm response team.

32. The system of claim 31, wherein the alarm notification system is a call center.

33. The system of claim 31, wherein the alarm notification system is a 911 call center, an ONSTAR call center, an ATX call center, a Cross Country call center, or ADT call center

34. The system of claim 1, wherein one of the sensors is a gps unit.

35. The system of claim 1, wherein one of the sensors is a cushion pressure sensor.

36. The system of claim 1, wherein one of the sensors is an accelerometer.

37. The system of claim 1, wherein one of the sensors is an infrared sensor operable to detect a presence of a passenger.

38. The system of claim 1 or 37, wherein the system remains in a sleep mode until awakened by a signal from one of the sensors, such as the infrared sensor detecting presence of the passenger.

39. The system of claim 37, wherein the infrared sensor can transmit output to the microcontroller to awaken the system from a sleep mode.

40. The system of claim 1, wherein one of the sensors is an engine state sensor.

41. The system of claim 40, wherein the engine state sensor detects whether an engine of the vehicle is running so that the system only is in an alarm condition detect mode when the engine state sensor senses the engine is running.

42. The system of claim 1, wherein the system is wirelessly connected to an external computing device through radio waves such as wireless LAN, Bluetooth, WiMAX, WiMAX2, LTE, and/or HSDPA.

43. The system of claim 42, wherein the external computing device communicates with the environmental detection and control system through an application resident on the external computing device to remotely monitor and/or control one or more alarm response actions.

44. The system of claim 42, wherein the external computing device is a smart phone or a tablet.

45. A method of detecting and controlling an environment of a vehicle, the method comprising:
detecting one or more environmental conditions of a cabin of the vehicle using the system of claim 1;
determining if an alarm condition exceeds a predetermined threshold; and
actuating one or more alarm response actions in response to the alarm condition being detected.

46. The method of claim 45, wherein the determining and actuating steps are carried out by an environmental detection and control system.

47. The method of claim 46, wherein the system of the preceding claims, the method further comprising:
causing one or more alarm response actions, by the microcontroller, when a temperature of the cabin is detected as being outside of a predetermined temperature range.

48. The method of claim 47, further comprising:
transmitting output, by the microcontroller as one of the alarm response actions, to a temperature control mechanism; and
causing the temperature of the cabin to move to the predetermined temperature range.

49. The method of claim 46, further comprising:
wirelessly connecting the system to a computer of the vehicle through radio waves such as wireless LAN, Bluetooth, WiMAX, WiMAX2, LTE, and/or HSDPA;
transmitting output, by the microcontroller, to the computer when the alarm condition is detected as one of the alarm response actions; and
emitting, by the vehicle, an alarm sound.

50. The method of claim 46, further comprising:
wirelessly connecting the system to an external computing device through radio waves such as wireless LAN, Bluetooth, WiMAX, WiMAX2, LTE, and/or HSDPA;
controlling, by the external computing device, the system when the alarm condition is detected as one of the alarm response actions.

51. The method of claim 50, wherein the external computing device communicates with the system through an application resident on the external computing device to remotely monitor and/or control one or more alarm response actions.

52. The method of claim 46, automatically transmitting, by the microcontroller, output to an alarm notification system when the alarm condition is detected; and the microcontroller automatically transmits output to the alarm notification system.

53. The method of claim 46, automatically transmitting, by the microcontroller, output to an alarm notification system when the alarm condition is detected; and the microcontroller automatically transmits one or more alarm notifications to individuals or an alarm response team.

54. The method of claim 46, wherein the system remains in a sleep mode until awakened by a signal from one of the sensors and detects presence of the passenger.

55. The system of claim 1 or 37, wherein the system is in operable processing connection with a web-based application adapted to monitor or control one or more functions of the system.
